(19) United States
(12) Patent Application Publication
(10) Pub. No.: US 2016/0102679 A1
(43) Pub. Date: Apr. 14, 2016

(54) ELECTROMAGNETIC SHAFT-WHEEL COUPLING FOR ARBITRARY DISTRIBUTION OF SHAFT TORQUE IN A TURBINE ENGINE

(71) Applicant: Rolls-Royce Corporation, Indianapolis, IN (US)

(72) Inventor: Benjamin M. Iwrey, Indianapolis, IN (US)

(21) Appl. No.: 14/847,578

(22) Filed: Sep. 8, 2015

Related U.S. Application Data
(60) Provisional application No. 62/063,883, filed on Oct. 14, 2014.

(51) Int. Cl. F04D 29/64; F01D 15/10; F04D 29/32; F04D 19/02; F04D 29/053

(52) U.S. Cl. CPC F04D 29/646; F04D 19/02; F04D 29/053; F04D 29/324; F01D 15/10; F05D 2220/32; F05D 2240/20; F05D 2260/30; F05D 2270/54

(57) ABSTRACT

A gas turbine engine system includes a compressor drive shaft and a compressor. The compressor includes a number of rotors. Each rotor includes a number of blades radially extending from a rotor wheel. The rotor wheels are concentric with the compressor drive shaft and separated from the compressor drive shaft by a gap. The rotors wheels are electromagnetically coupled to the compressor drive shaft so as to rotate with or about the compressor drive shaft at variable speeds.

### CROSS REFERENCE TO RELATED APPLICATIONS

This application claims priority to and the benefit of U.S. Provisional Patent Application No. 62/063,883 filed 14 Oct. 2014, the disclosure of which is now expressly incorporated herein by reference.

### FIELD OF THE DISCLOSURE

The present disclosure relates generally to gas turbine engines. More specifically, the present disclosure relates to the shaft-wheel design of rotors in a gas turbine engine.

### BACKGROUND

Gas turbine engines are used to power aircraft, watercraft, power generators, and other vehicles and machines. Gas turbine engines typically include one or more compressors, a combustor, and one or more turbines. In typical aerospace applications, a fan or propeller is used to draw air into the engine and feeds the drawn-in air to the gas turbine core, which includes one or more compressors, a combustor, and one or more turbines. The compressor includes alternating stages of rotors (e.g., rotating disks with blades) and stators (e.g., static vanes), which increase the pressure of the drawn-in air as it travels through the gas turbine core. The compressor thus outputs higher-pressure air, which it delivers to the combustor. In the combustor, the fuel is mixed with the higher-pressure air and is ignited by an igniter. The products of the combustion reaction that occurs in the combustor (e.g., hot gas) are directed into a turbine. The turbine is typically made up of an assembly of rotors (e.g., rotating discs with blades), which are attached to turbine shafts, nozzle guide vanes, casings, and other structures. The turbine converts the thermal energy supplied by the combustion products into kinetic energy. The work extracted from the combustion products by the turbine may be used to drive the fan, the compressor, and, sometimes, an output shaft. Leftover products of the combustion are exhausted out of the engine and may provide thrust in some configurations.

Aerospace applications of gas turbine engines include turboshaft, turboprop, and turbofan engines. In typical aerospace applications, the gas turbine engine provides thrust to propel the aircraft, and also supplies power for engine accessories and aircraft accessories. Mechanical power is transferred from turbines to compressors through shaft and spline systems, with bearings providing axial and radial positioning of the rotating components. A drive shaft typically links the turbine and compressor sections of the turbine engine. In turbine engines having multiple turbine and compressor sections, there may be multiple, concentric, independently rotatable drive shafts. For example, a high pressure shaft may link a high pressure compressor with a high pressure turbine, while a low pressure shaft links the fan with a low pressure turbine. The low pressure shaft may be concentric with and disposed within the high pressure shaft.

A compressor of the turbine engine may have multiple stages, each of which includes a rotor and a stator. Alternatively, the compressor may be embodied as a centrifugal or mixed-flow compressor, or as a single- or multi-stage fan. In a multistage compressor, the rotor of each compressor stage is equipped with rotor blades. Typically, the compressor rotors are mechanically engaged with a drive shaft and rotate in common with the drive shaft. The stator of each stage is equipped with stationary vanes, which do not rotate and are not connected to the compressor drive shaft. Thus, each compressor stage is made up of alternating rows of rotating and non-rotating blades/vanes.

### SUMMARY

The present application discloses one or more of the features recited in the appended claims and/or the following features which, alone or in any combination, may comprise patentable subject matter.

In an example 1, a gas turbine engine system includes a turbine engine including: a compressor drive shaft; a compressor having a plurality of rotor wheels and a plurality of blades extending radially from each rotor wheel, each of the rotor wheels being rotatable with the compressor drive shaft and rotatable about the compressor drive shaft; and an electromagnetic coupler electromagnetically coupling the rotor wheels to the compressor drive shaft; and control circuitry to selectively vary a supply of electrical energy to the electromagnetic coupler.

An example 2 includes the subject matter of example 1, wherein the electromagnetic coupler includes a shaft-side electromagnetic coupler mounted to the compressor drive shaft. An example 3 includes the subject matter of example 1 or example 2, wherein the shaft-side electromagnetic coupler is disposed adjacent an outer diameter of the compressor drive shaft. An example 4 includes the subject matter of example 3, wherein the shaft-side electromagnetic coupler includes a magnetic material. An example 5 includes the subject matter of example 1 or example 2, wherein the electromagnetic coupler includes a wheel-side electromagnetic coupler mounted to the multistage axial compressor. An example 6 includes the subject matter of example 5, wherein the wheel-side electromagnetic coupler is disposed adjacent an inner diameter of each rotor wheel. An example 7 includes the subject matter of example 6, wherein the wheel-side electromagnetic coupler includes a magnetic material, and the shaft-side electromagnetic coupler includes a magnetic material having the opposite polarity as the magnetic material of the wheel-side electromagnetic coupler. An example 8 includes the subject matter of any of the preceding examples, wherein the electromagnetic coupler includes a wheel-side electromagnetic coupler disposed adjacent an inner diameter of each rotor wheel and a shaft-side electromagnetic coupler disposed adjacent an outer diameter of the compressor drive shaft. An example 9 includes the subject matter of example 8, wherein the wheel-side electromagnetic coupler and the shaft-side electromagnetic coupler each include a solenoid array. An example 10 includes the subject matter of any of the preceding examples, wherein each of the rotor wheels is concentric with the compressor drive shaft and separated from the compressor drive shaft by a gap. An example 11 includes the subject matter of any of the preceding examples, and includes a power supply to supply electrical energy to the shaft-side electromagnetic coupler and the wheel-side electromagnetic coupler. An example 12 includes the subject matter of example 9, wherein the power supply includes a generator coupled to the compressor drive shaft. An example 13 includes the subject matter of any of the preceding examples, and includes a non-electromagnetic coupler to couple the compressor drive shaft to the rotor wheels in response to an electrical failure in the gas turbine engine system. An example 14 includes the subject matter of example 11, wherein the non-electromagnetic coupler includes a spring-loaded clutch. An example 15 includes the subject matter of any of the preceding examples, including shaft torque control logic embodied in one or more non-transitory machine readable storage media, wherein the shaft torque control logic is executable by the electrical circuitry to cause the gas turbine engine system to selectively vary the supply of electrical energy to the electromagnetic coupler to arbitrarily vary the distribution of shaft torque among the rotor wheels. An example 16 includes the subject matter of any of the preceding examples, including shaft torque control logic embodied in one or more non-transitory machine readable storage media, wherein the shaft torque control logic is executable by the electrical circuitry to cause the gas turbine engine system to selectively operate in a plurality of different states, wherein the plurality of different states includes (i) a “locked” state in which torque is transmitted from the compressor drive shaft to the rotor wheels; and (ii) a “slipped” state in which torque transfer from the compressor drive shaft to the rotor wheels is modulated. An example 17 includes the subject matter of example 16, wherein the shaft torque control logic is executable by the electrical circuitry to cause the gas turbine engine system to operate in (iii) a “pressed” state in which the rotation speed of the rotor wheels is higher than the rotation speed of the compressor drive shaft. An example 18 includes the subject matter of any of the preceding examples, wherein the compressor includes: an axial multistage compressor, a centrifugal compressor, a mixed-flow compressor, a single-stage fan, or a multistage fan.

In an example 19, a gas turbine engine includes: a compressor drive shaft; a compressor having a plurality of compressor stages, each stage including a rotor and a stator, each rotor including a rotor wheel and a plurality of blades extending radially from the rotor wheel, each of the rotor wheels being concentric with and mechanically disengaged from the compressor drive shaft; and an electromagnetic coupler electromagnetically coupling the rotor wheels to the compressor drive shaft.

An example 20 includes the subject matter of example 19, wherein the electromagnetic coupler includes a shaft-side coupler disposed adjacent an outer diameter of the compressor drive shaft and a wheel-side coupler disposed adjacent an inner diameter of each rotor wheel. An example 21 includes the subject matter of example 20, wherein the outer diameter of the compressor drive shaft is separated from the inner diameter of each rotor wheel by a gap. In an example 22, a compressor for a gas turbine engine includes: a plurality of compressor stages, each stage including a rotor and a stator, each rotor including a rotor wheel and a plurality of blades extending radially from the rotor wheel; and an electromagnetic coupler disposed adjacent an inner diameter of each of the rotor wheels. An example 23 includes the subject matter of example 22, and includes a compressor drive shaft and an electromagnetic coupler disposed about an outer diameter of the compressor drive shaft, wherein the rotor wheels are concentric with and mechanically disengaged from the compressor drive shaft. An example 24 includes the subject matter of any of examples 22 or 23, wherein the compressor is a multistage axial compressor.

In an example 25, a control unit for a gas turbine engine includes a compressor and a compressor drive shaft, the compressor having a plurality of bladed rotor wheels concentric with the compressor drive shaft, the control unit including electrical circuitry and shaft torque control logic embodied in one or more non-transitory machine readable storage media, wherein the shaft torque control logic is executable by the electrical circuitry to cause an intensity of a magnetic field between the bladed rotor wheels and the compressor drive shaft to vary to generate a continuously variable torque between the compressor drive shaft and the bladed rotor wheels.

### BRIEF DESCRIPTION OF THE DRAWINGS

This disclosure is illustrated by way of example and not by way of limitation in the accompanying figures. The figures may, alone or in combination, illustrate one or more embodiments of the disclosure. Elements illustrated in the figures are not necessarily drawn to scale. Reference labels may be repeated among the figures to indicate corresponding or analogous elements.

FIG. 1 is a simplified block diagram of at least one embodiment of a gas turbine engine system including at least one multistage compressor and compressor shaft torque control logic as disclosed herein;

FIG. 2 is a simplified meriodonal sectional view of at least one embodiment of a gas turbine engine, which may be implemented in the gas turbine engine system of FIG. 1, where the gas turbine engine includes multistage compressors that are electromagnetically coupled to their respective drive shafts as disclosed herein;

FIG. 3 is a simplified axial sectional view of at least one embodiment of a compressor drive shaft, a compressor rotor wheel (with rotor blades omitted), and a compressor wheel-to-shaft coupling, and showing, schematically, electrical connections to shaft torque control logic, as disclosed herein;

FIG. 4A is a simplified meridional view of at least one embodiment of a multistage compressor including electromagnetic wheel-to-shaft couplings as disclosed herein;

FIG. 4B is a simplified meridional view of at least one other embodiment of a multistage compressor including electromagnetic wheel-to-shaft couplings as disclosed herein;

FIGS. 5 and 6 are simplified schematic views of equilibrium and phased states of at least one embodiment of an electromagnetic wheel-to-shaft coupling as disclosed herein;

FIG. 7 is a simplified flow diagram of at least one embodiment of a process for varying shaft to rotor wheel torque distribution, which may be executed by the gas turbine engine system of FIG. 1; and

FIG. 8 is a simplified block diagram of at least one embodiment of a control unit for performing shaft to rotor torque distribution as disclosed herein.

### DETAILED DESCRIPTION OF THE DRAWINGS

While the concepts of the present disclosure are susceptible to various modifications and alternative forms, specific embodiments thereof are shown by way of example in the drawings and are described in detail below. It should be understood that there is no intent to limit the concepts of the present disclosure to the particular forms disclosed. On the contrary, the intent is to cover all modifications, equivalents, and alternatives consistent with the present disclosure and the appended claims.

In order for a multistage compressor to operate efficiently, the different stages of the compressor need to work in unison, or in an equilibrium condition. Compressors are therefore designed to achieve the “equilibrium” condition at a desired operating point, which is typically determined based on performance (e.g., pressure ratio, efficiency) and operability (e.g., surge margin, flutter margin) requirements. Thus, situations in which the compressor operates at an off-design condition (e.g., low shaft speed, higher pressure ratio) can upset the equilibrium among the different bladerows.

As an example, if a multistage axial compressor is forced to operate at a low shaft speed (where low shaft speed is an off-design condition), the reduced blade speed in the frontward stages results in a low density rise, which increases the throughflow velocity in the rearward stages. The higher throughflow velocity in the rearward stages forces the rearward stages into a choke condition. When this happens, the rearward stages limit the inlet flow, which then forces the frontward stages into a stall/surge condition, so that the rearward stages end up operating as, essentially, loss generators, while the frontward stages operate near or beyond their respective stability limits. The resulting matching problems can inhibit performance and operability of the compressor.

Standard approaches to addressing these matching problems include the use of a multi-spool architecture (in which compressors connected to different, concentric shafts run at different speeds), variable vanes (which can be rotated about their respective spanwise axes to change inlet and exit flow angles at different operating conditions), bleeds (which divert some of the airflow out of the main flow path so as to reduce the pressure ratio of upstream stages), or the implementation of a geared system (which can be used to step down the shaft speed for a particular rotor or series of rotors).

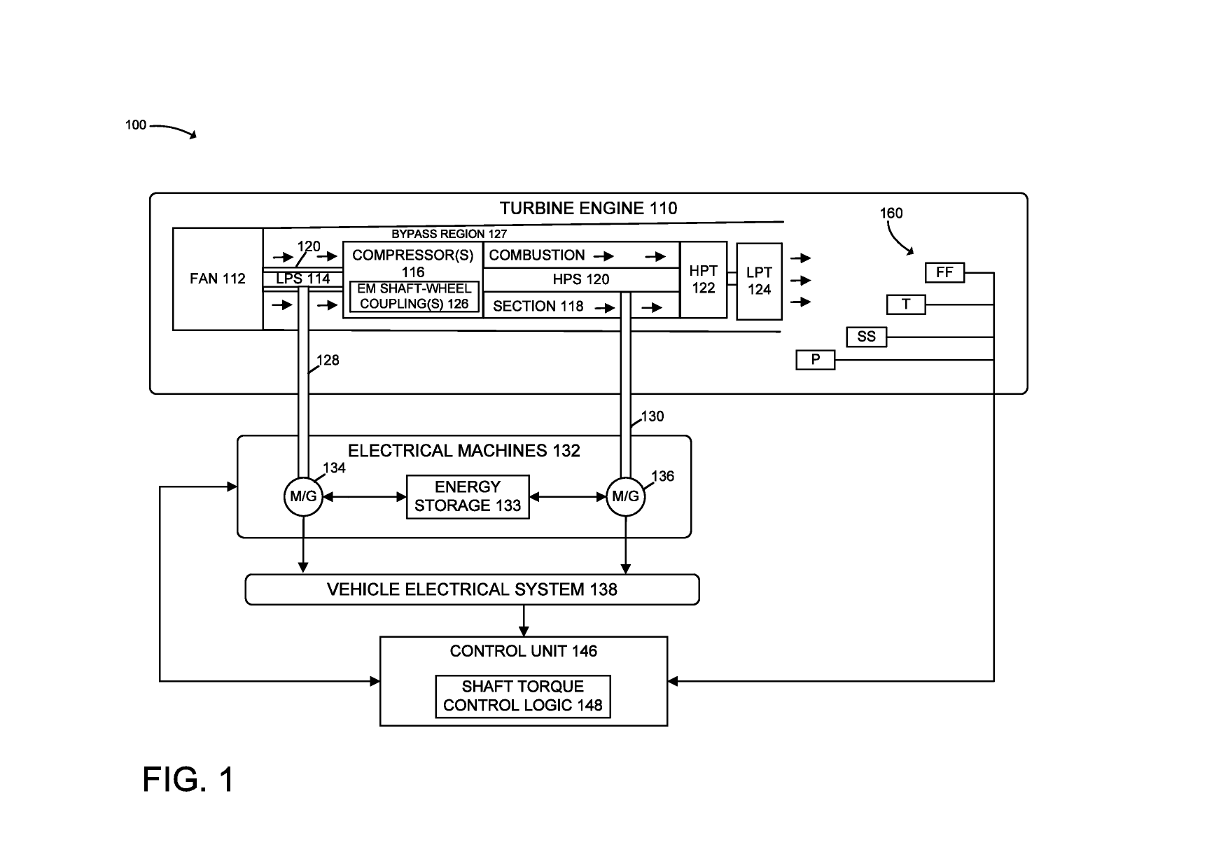

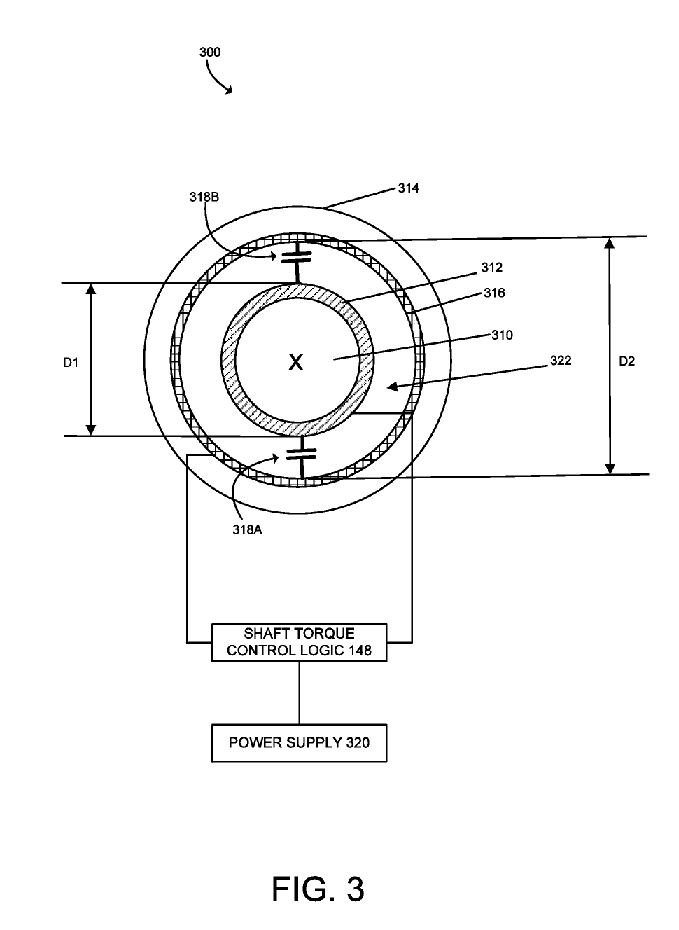

Referring now to FIG. 1, an embodiment of a gas turbine engine system 100 includes a turbine engine 110, electrical machines 132, a vehicle electrical system 138, and a control unit 146. As shown in the subsequent figures and described in more detail below, the turbine engine 110 includes one or more compressors 116 and turbines 122, 124. Any one or more of the compressors 116 is implemented using an electromagnetic shaft-wheel coupling 126, in which the compressor rotor wheels are electromagnetically coupled, rather than mechanically engaged, with their respective drive shafts. Electrical energy (e.g., current) is supplied to shaft-side and wheel-side components of the electromagnetic shaft-wheel coupling 126 as shown in FIG. 3, described below. The application of electrical energy to the components of the electromagnetic shaft-wheel coupling 126 causes the circumferential phase and magnetic field intensity between the shaft-side and wheel-side components of the electromagnetic coupling to vary, thereby transferring torque from the drive shafts to the electromagnetically-coupled wheels of the compressor rotors. Shaft torque control logic 148 executed by the control unit 146 controls the supply of electrical energy to the compressor drive shafts and to the shaft-side and wheel-side components of the electromagnetic coupling 126. In this way, the gas turbine engine system 100 can selectively modulate the amount of torque transferred from the compressor drive shafts to the compressor rotor wheels. For example, the shaft torque can be arbitrarily distributed among the bladerows of the different stages of a multistage compressor, in order to optimize rotor speeds for varying operating conditions, or for other reasons.

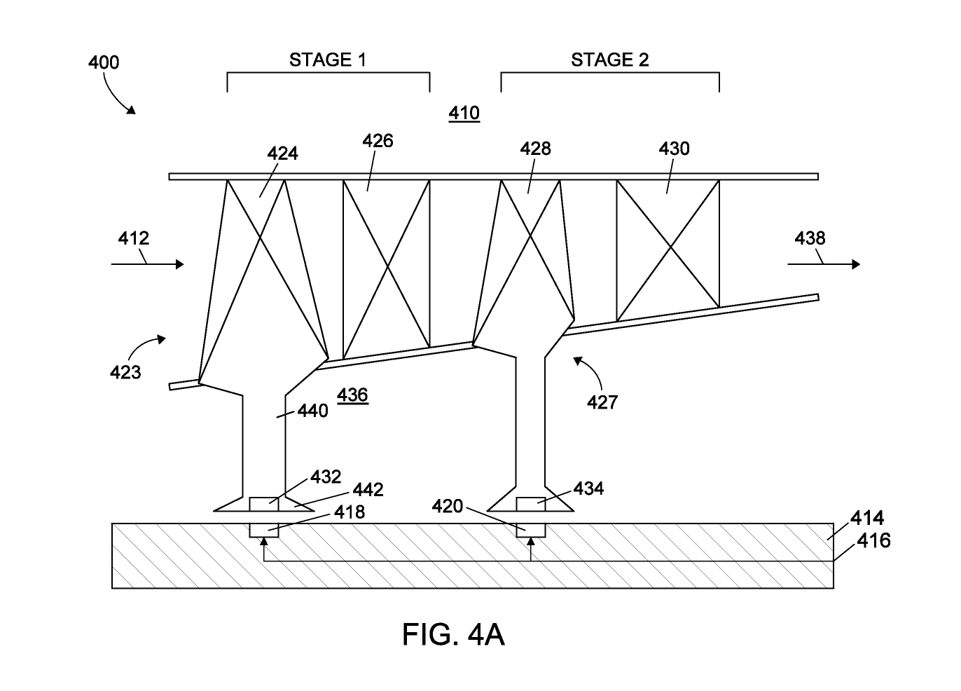

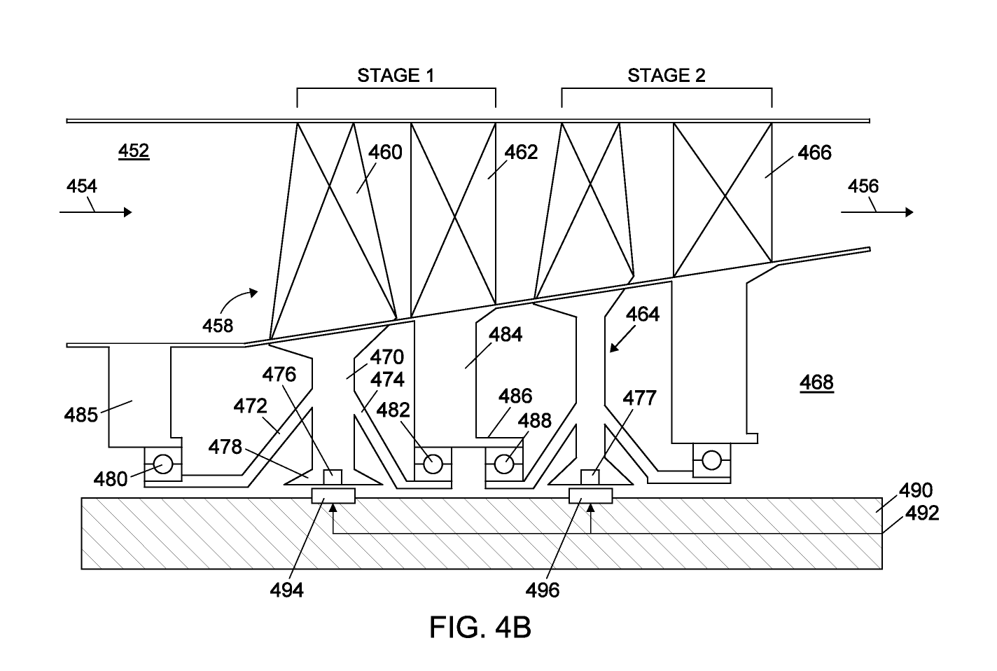

It should be noted that, while the illustrative embodiments show the electromagnetic shaft-wheel coupling implemented in a compressor, the electromagnetic shaft-wheel coupling can be implemented with the turbine wheel in a similar manner. That is, the shaft torque and speed of a compressor or turbine drive shaft can be modulated in a similar fashion. For example, the arrangement shown in FIG. 4A or FIG. 4B can modified to show a simplified view of a turbine implementation by reversing the inlet and outlet directional arrows 412, 438.

Referring now in more detail to the embodiment of FIG. 1, the illustrative turbine engine 110 is a multi-shaft turbofan gas turbine engine configured for aerospace applications; however, aspects of the present disclosure are applicable to other types of turbine engines, including various types of turboprop and turboshaft systems and turbine engines that are configured for other, non-aerospace types of applications (e.g., marine, etc.). In the turbine engine 110, a fan 112 (e.g., a fan, variable pitch propeller, etc.) draws air into the engine 110. Some of the air may bypass other engine components via a bypass region 127 (e.g., a bypass duct), and thereby generate propulsive thrust. The remaining air is delivered to one or more compressors 116. In some embodiments, a low pressure compressor may increase the pressure of air received from the fan 112, and a high pressure compressor may further increase the pressure of air received from the low pressure compressor. In any event, the compressor(s) 116 increase the pressure of the air and forward the higher-pressure air to a combustor 118.

In the combustor 118, the pressurized air is mixed with fuel, which is supplied to the combustor 118 by a fuel supply (not shown). Typically, a flow meter, flow control valve, or similar device (e.g., a fuel flow sensor, FF 160) monitors and/or regulates the flow of fuel into the combustor 118. An igniter (not shown) is typically used to cause the mixture of air and fuel to combust. The high-energy combusted air is directed to one or more turbines 122, 124. In the illustrative embodiment, a high pressure turbine 122 is disposed in axial flow series with a low pressure turbine 124. The combusted air expands through the turbines 122, 124, causing them to rotate. The combusted air is then exhausted through, e.g., a propulsion nozzle (not shown), which may generate additional propulsive thrust.

The rotation of the turbines 122, 124 causes the engine drive shafts 114, 120, to rotate. More specifically, rotation of the low pressure turbine drives a low pressure shaft 114, which drives the fan 112. Rotation of the high pressure turbine 122 drives a high pressure shaft (or “compressor drive shaft”) 120, which drives the compressor(s) 116. In some embodiments, the shafts 114, 120 may be concentrically disposed. In some embodiments, more than two shafts 114, 120 may be provided. For example, in some embodiments, an intermediate shaft is disposed concentrically between the low pressure shaft 114 and the high pressure shaft 120 and supports an intermediate-pressure compressor and turbine.

The illustrative turbines 122, 124 additionally drive one or more electrical machines 132 (via, e.g., a power take-off assembly or “more” electric technology). The electrical machines 132 may be embodied as, e.g., electric motors or motor/generators. The illustrative low pressure turbine 124 drives a motor/generator 134 via the low pressure shaft 114 and a power take-off assembly 128. The illustrative high pressure turbine 122 drives a motor/generator 136 via the high pressure shaft 120 and a power take-off assembly 130. The electrical machines 132 can generate electrical power, which may be supplied to an energy storage 133 or to a vehicle electrical system 138, for example. For instance, the motor/generator 134 may generate electrical power that is supplied to other components or systems of the aircraft or other vehicle to which it is coupled. The motor/generator 136 may operate similarly. Each or either of the motor/generators 134, 136 may have a motor mode in which the motor/generator 136 receives electrical energy from, for example, the energy storage 133 or the vehicle electrical system 138, and converts the received electrical energy into rotational power, which is then supplied to the high pressure turbine 122 via the power take-off assembly 130. For clarity, it is noted that although the electromagnetic shaft-wheel coupling 126 may be embodied as a motor or a motor/generator in some cases, the electromagnetic shaft-wheel coupling 126 is a separate structure from, and serves a different purpose than, the electrical machines 132.

The control unit 146 controls the overall operation of the engine 110 or various components of the turbine engine system 100. For example, the control unit 146 may be embodied as a Full Authority Digital Engine Controller or FADEC, or may be embodied as a dedicated controller or electrical circuitry. The illustrative control unit 146 is in electrical communication with the electromagnetic shaft-wheel coupling 126 to send control signals to the electromagnetic shaft-wheel coupling 126, e.g., to vary the torque distribution from compressor drive shafts to compressor rotor wheels, as described further below. The illustrative control unit 146 is powered by electrical energy generated by the electrical machines 132 and provided to the vehicle electrical system 138 during operation of the turbine engine 110.

The control unit 146 receives electrical signals from a number of different sensors 160, which are installed at various locations on the turbine engine 110 and/or other components of the system (e.g., the compressor 116 and compressor drive shaft 120), to sense and/or measure various physical parameters such as temperature (T), shaft speed (SS), air pressure (P), and fuel flow (FF). Other parameters that may be measured by sensors 160 or calculated using data obtained by one or more sensors 160 include rotational speed of a rotor blade/wheel, magnetic field intensity, circumferential phase, electrical current, air flow, pressure ratio, surge margin, flutter margin, etc. When the turbine engine 110 is in operation, these parameters represent various aspects of the current operating condition of the turbine engine 110. The sensors 160 supply electrical sensor data signals representing instantaneous values of the sensed/measured information over time, to the control unit 146. In response to the sensor data signals, the control unit 146 supplies various commands to various components of the engine system 100, in order to control various aspects of the operation of the turbine engine system 100. The control unit 146 executes the shaft torque control logic 148 from time to time during operation of the turbine engine system 100 (e.g., in response to changes in operating conditions), and sends control signals to components of the electromagnetic shaft-wheel coupling 126.

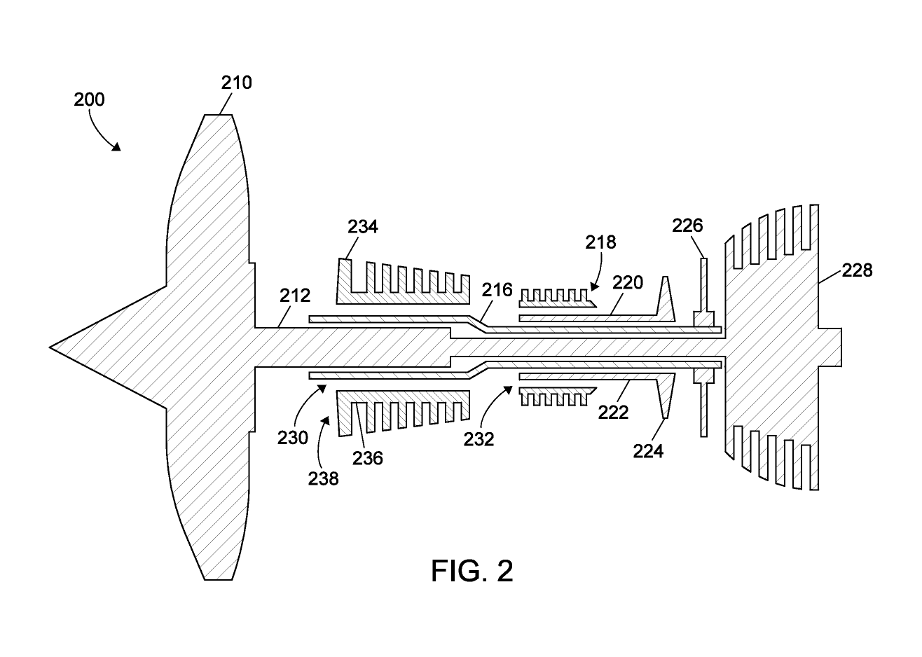

Referring now to FIG. 2, a greatly simplified view of an embodiment 200 of the turbine engine 110 is shown. The embodiment 200 includes a fan (or low pressure (LP) compressor) 210, a low pressure (LP) shaft 212, an intermediate pressure (IP) compressor 214, an IP shaft 216, a high pressure (HP) compressor 218, an HP shaft 220, an HP turbine 224, an IP turbine 226, and an LP turbine 228. The shafts 212, 216, 220 are concentrically disposed. Both the IP compressor 214 and the HP compressor 218 are mechanically disengaged from and electromagnetically coupled to their respective drive shafts 216, 220 as disclosed herein. As such, compressor rotors 238, 218 are separated from their respective shafts 216, 220 by gaps 230, 232 (e.g., air), respectively. The gaps 230, 232 extend around the circumference of the shafts 216, 220 and are disposed between the shafts 216, 220 and the rotors 238, 218, respectively. The illustrative IP compressor 214 is a multistage compressor that includes a number of axially aligned stages, where each stage includes a rotor 238. Each rotor 238 includes a number of blades 234 that radially extend from a rotor wheel or hub 234. The rotors 218 of the HP compressor 218 are configured in a similar manner. While in FIG. 2 all of the rotor blades (e.g., blades 234) are shown as connected to a single wheel or hub (e.g., wheel/hub 236), individual rotors or groups of rotors may have separate rotor wheels/hubs in other embodiments. It should be noted that while FIG. 2 depicts a multistage axial compressor, aspects of this disclosure are analogously applicable to centrifugal compressors, mixed-flow compressors, single-stage fans, multi-stage fans, or other types of compressors or fans.

Referring now to FIG. 3, an embodiment 300 of the electromagnetic shaft-wheel coupling 126 is shown. A compressor drive shaft 310 has an outer diameter, D1. A compressor rotor wheel 314 (shown with blades omitted) has an inner diameter, D2. The compressor drive shaft 310 and the compressor rotor wheel 314 are separated by a circumferential gap 322 (e.g., air). A shaft-side electromagnetic coupler 312 is disposed adjacent the outer diameter D1. A wheel-side electromagnetic coupler 316 is disposed adjacent the inner diameter D2. Illustratively, the electromagnetic couplers 312, 316 are circumferentially arranged, with the electromagnetic coupler 312 being disposed about an outer circumference of the drive shaft 310 and the electromagnetic coupler 316 being disposed about an inner circumference of the rotor wheel 314. Each of the electromagnetic couplers 312, 316 includes a magnetic material, and may be embodied as, for instance, an induction motor, a series of radially arranged electromagnets, solenoids, solenoid arrays, magnetorheological fluid, or other suitable material, which may be configured to form an electromagnetic “track” or bearing. The electromagnetic couplers 312, 316 receive electrical energy (e.g., current) from a power supply 320, via the shaft torque control logic 148, which controls the application of electrical energy to the electromagnetic couplers 213, 316 as described herein. The power supply 320 may be embodied as, for example, the energy storage 133 or a power supply of the vehicle electrical system 138. The power supply 320 and/or the energy storage 133 may be embodied as, e.g., a battery or a capacitor. A non-electromagnetic coupling mechanism 318 is coupled to both the drive shaft 310 and the rotor wheel 314. The non-electromagnetic coupling mechanism 318 is an optional feature that can be provided if, for example, a mechanical coupling (e.g., a mechanical clutch) is desired, e.g., as an emergency or “backup” coupling mechanism. The illustrative non-electromagnetic coupling mechanism 318 is biased so that the drive shaft 310 and the rotor wheel 314 are directly (e.g., mechanically) connected in the event that an electrical failure occurs in the turbine engine system 100. As such, the non-electromagnetic coupling mechanism 318 may be embodied as a spring-loaded clutch, such as a friction clutch or brake. Typically, the non-electromagnetic coupling mechanism 318 includes a pair of opposing clutch elements that are circumferentially symmetrically arranged.

Referring now to FIG. 4A, an embodiment 400 of the compressor 116 is shown. Inlet arrow 412 and outlet arrow 438 indicate the direction of air flow through the compressor 400. In the embodiment 400, a drive shaft 414 includes a conduit (e.g., insulated wiring) 416 to supply electrical energy (e.g., current) to shaft-side electromagnetic couplers 418, 420. Another conduit (not shown) supplies electrical energy to wheel-side electromagnetic couplers 432, 434, in some embodiments. A first stage of the compressor 400 includes a rotor 423 and a stator 426. A second stage of the compressor 400 is axially aligned with the first stage and includes a rotor 427 and a stator 430. The compressor rotors 423, 427 are supported by a rotor hub 436, while the non-rotating stators 426, 430 are supported by a compressor casing 410. The rotor 423 includes a blade 424, a blade stem 440, and a blade root 442. A wheel-side electromagnetic coupler 432 is disposed in the blade root 442 and aligned with the shaft-side electromagnetic coupler 418. The rotor 427 is configured similarly, with a wheel-side electromagnetic coupler 434 disposed in the blade root and aligned with the shaft-side electromagnetic coupler 420. While not specifically shown in FIG. 4A, it should be understood that each rotor 423, 427 includes many such blade structures disposed circumferentially about the hub 436. As such, a wheel-side electromagnetic coupler (e.g., coupler 432) is disposed in the blade root of each blade structure of each rotor 423, 427, and corresponding shaft-side electromagnetic couplers (e.g., coupler 432) are disposed about the outer circumference of the shaft 414 and are axially aligned with the rotors 423, 427, in some embodiments. As such, the shaft-side electromagnetic couplers disposed about the shaft 414 and aligned with a particular rotor 423, 427 may be referred to as a “shaft track,” while the electromagnetic couplers arranged in the blade roots of a particular rotor may be referred to as a “wheel track.” The shaft-side electromagnetic couplers 418, 420 and wheel-side electromagnetic couplers 432, 434 may be embodied using similar material as the shaft-side electromagnetic coupler 312 and wheel-side electromagnetic coupler 316, described above. While the wheel-side electromagnetic couplers 432, 434 are shown in FIG. 4A as disposed in the blade roots 442, 444, other configurations are also possible. For example, the wheel-side electromagnetic couplers 432, 434 may be arranged on each side of a shaft slip surface (e.g. a blade-blade coupling) in other embodiments. Also, in some embodiments, shaft-root bearings may be employed to maintain radial rigidity of the rotors 423, 427, or for other reasons. Alternatively or in addition, slip surface or foil bearings may be disposed between adjacent rotor wheels to maintain axial rigidity of the rotors 423, 427, or for other reasons.

Referring now to FIG. 4B, an embodiment 450 of the compressor 116 is shown. Aspects of the embodiment of FIG. 4B are similar to the embodiment of FIG. 4A; however, in the embodiment of FIG. 4B, rotors 458, 464 are radially supported by the hub 468 as described below. Inlet arrow 454 and outlet arrow 456 indicate the direction of air flow through the compressor 450. In the embodiment 450, a drive shaft 490 includes a conduit (e.g., insulated wiring) 492 to supply electrical energy (e.g., current) to shaft-side electromagnetic couplers 494, 496. Another conduit (not shown) supplies electrical energy to wheel-side electromagnetic couplers 476, 477, in some embodiments. A first stage (“stage 1”) of the compressor 450 includes the rotor 458 and a stator 462. A second stage (“stage 2”) of the compressor 450 is axially aligned with the first stage and includes the rotor 464 and a stator 466. The compressor rotors 458, 464 and the stators 462, 466 are supported by a hub 468. The (non-rotating) stators 462, 466 are also supported by a compressor casing 452. The rotor 458 includes a blade 460, a blade stem 470, and a blade root 478. A wheel-side electromagnetic coupler 476 is disposed in the blade root 478 and aligned with the shaft-side electromagnetic coupler 494. The rotor 458 is rotatably coupled to root portions 484, 485 of the adjacent stators 462 (where the top portion of stator 485 is not shown), by one or more supports 472, 474 and bearings 480, 482. The supports 472, 474 supply radial rigidity to the rotor 458 while the bearings 480, 482 allow the rotor 458 to rotate independently of the stators 485, 462 and independently of the shaft 490. The rotor 464 is configured similarly, with a wheel-side electromagnetic coupler 477 disposed in the blade root and aligned with the shaft-side electromagnetic coupler 496.

While not specifically shown in FIG. 4B, it should be understood that each rotor 458, 464 includes many such blade structures disposed circumferentially about the hub 468. As such, a wheel-side electromagnetic coupler (e.g., coupler 476) is disposed in the blade root of each blade structure of each rotor 458, 464, and corresponding shaft-side electromagnetic couplers (e.g., couplers 494, 496) are disposed about the outer circumference of the shaft 490 and are axially aligned with the rotors 458, 464, in some embodiments. As such, the shaft-side electromagnetic couplers disposed about the shaft 490 and aligned with a particular rotor 458, 464 may be referred to as a “shaft track,” while the electromagnetic couplers arranged in the blade roots of a particular rotor may be referred to as a “wheel track.” The shaft-side electromagnetic couplers 494, 496 and wheel-side electromagnetic couplers 476, 477 may be embodied using similar material as the shaft-side electromagnetic coupler 312 and wheel-side electromagnetic coupler 316, described above. While the wheel-side electromagnetic couplers 476, 477 are shown in FIG. 4B as disposed in the blade roots of the rotors 458, 464 (e.g., blade root 478), other configurations are also possible. For example, the wheel-side electromagnetic couplers 476, 477 may be arranged on each side of a shaft slip surface (e.g. a blade-blade coupling) in other embodiments.

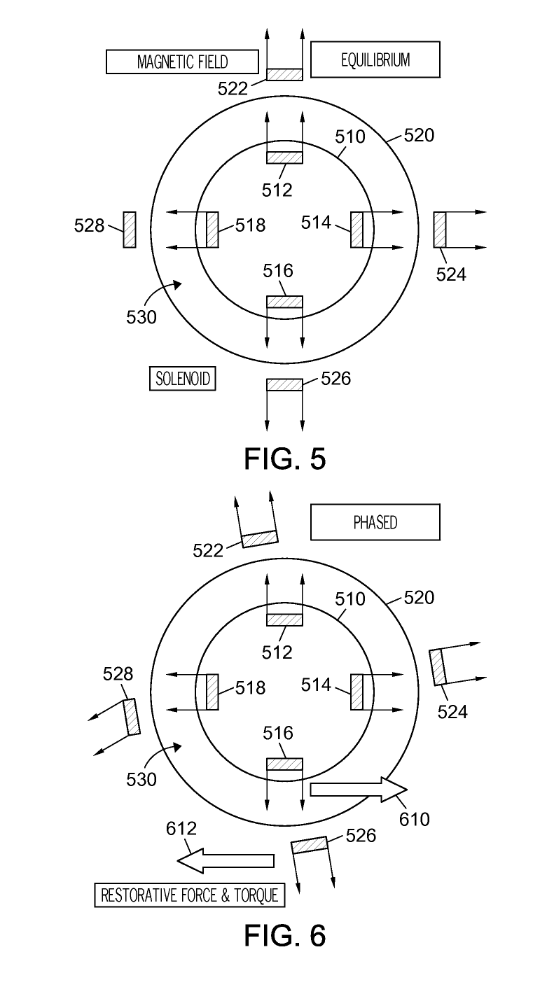

Referring now to FIGS. 5-6, simplified schematic diagrams showing different operational states of the electromagnetic couplers described herein are shown. In FIGS. 5 and 6, a compressor drive shaft 510 is equipped with electromagnetic couplers 512, 514, 516, 518. A compressor rotor wheel 520 is concentric with the shaft 510 and separated from the shaft 510 by a gap 530 (e.g., air). The compressor rotor wheel 520 is equipped with electromagnetic couplers 522, 524, 526, 528. The arrows directing away from the couplers 512, 514, 516, 518, 522, 524, 526, 528 indicate the direction of the magnetic field of the respective coupler. FIG. 5 illustrates an equilibrium state in which the rotational speed of the shaft 510 and the rotational speed of the wheel 520 are the same (e.g., zero or some speed value, during a running condition). In operation, (e.g., while the shaft 510 is rotating), the “equilibrium” state exhibits some amount of circumferential phasing in order to generate a torque between the electromagnetic couplers 512, 514, 516, 518, 522, 524, 526, 528. FIG. 6 illustrates a “phased” state in which there is a restorative torque between the shaft 510 and the wheel 520. By modulating the intensity of the magnetic field and the phasing scheme, the gas turbine engine system 100 can generate a range of shaft-wheel torque in order to, for example, accelerate or decelerate the rotational speed of the wheel 520 and/or accelerate or decelerate the rotational speed of the shaft 510. A new equilibrium state can be achieved in which the wheel and shaft speed differ by some amount.

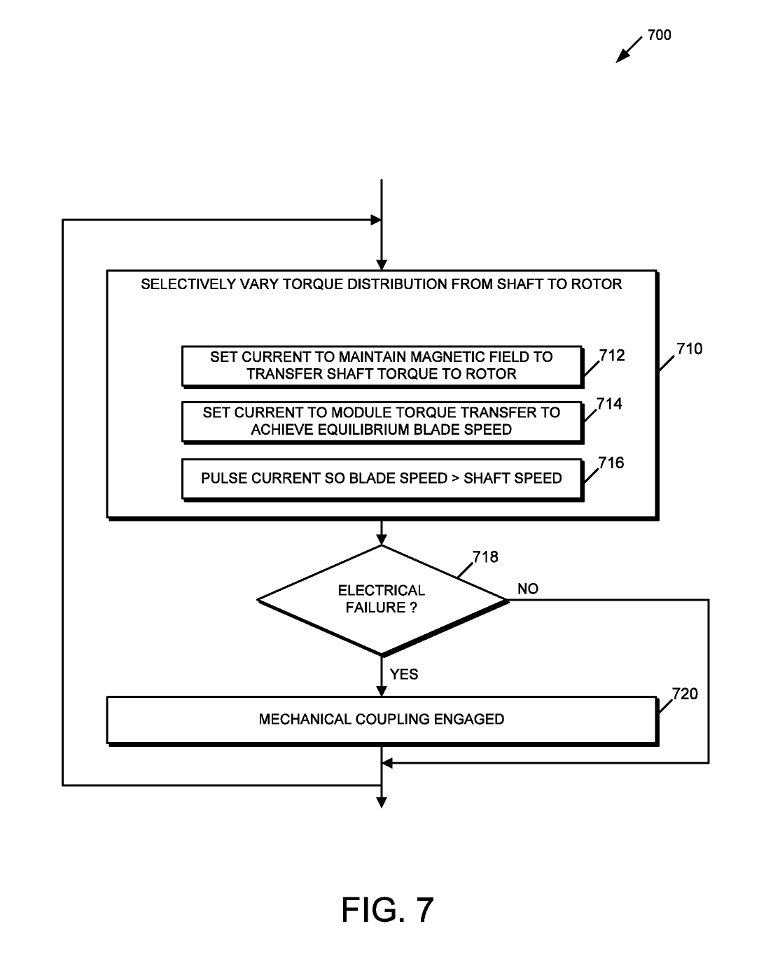

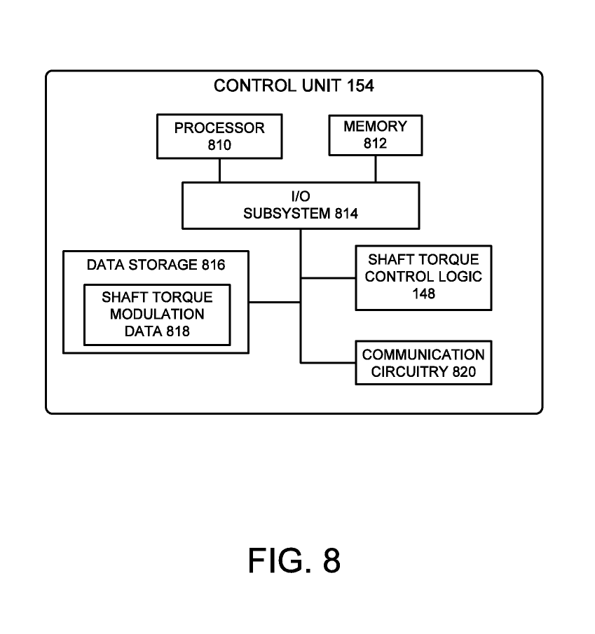

Referring now to FIG. 7, an illustrative process 700 for controlling shaft-wheel torque distribution in a turbine engine system is shown. Aspects of the method 700 may be embodied as electrical circuitry, computerized programs, routines, logic and/or instructions executed by the turbine engine system 100, for example by the shaft torque control logic 148 and/or other components of the control unit 146. At block 710, the gas turbine engine system 100 selectively varies the torque distribution from a drive shaft to a rotor wheel (e.g., a compressor or turbine drive shaft and rotor wheel). To do this, the system 100 may: (i) supply an amount of electrical energy (e.g., current) to the electromagnetic shaft-wheel coupler that is sufficient to maintain a magnetic field such that the shaft torque is transferred to the rotor wheel (e.g., a “locked” or 1:1 matching state) (block 712); (ii) supply an amount of electrical energy (e.g., current) to modulate the torque transfer from the drive shaft to the rotor wheel to achieve an equilibrium blade speed (e.g., a “slipped” or 1:<1 state) (block 714); or (iii) pulse the electrical energy (e.g., current) supplied to the electromagnetic shaft-wheel coupler so that the blade speed is greater than the shaft speed (e.g., a “pulsed” or 1:>1 state) (block 716). The system 100 determines how to vary the shaft-wheel torque distribution based on current operating conditions of the turbine engine 110, e.g., whether the current operating conditions are within or outside of the conditions for which the design of the compressor was optimized. For example, the system 100 may selectively execute logic corresponding to any of the blocks 712, 714, 716 in response to changes in shaft speed, air flow, pressure ratio, surge margin, flutter margin, and/or other measurable parameters. Further, the system 100 may, at block 710, vary the shaft-wheel torque distribution differently for different rotors or groups of rotors, in some embodiments. In some embodiments, the system 100 may refer to shaft torque modulation data 818 (FIG. 8), in making a determination as to whether or how to vary the shaft-wheel torque distribution. The shaft torque modulation data 818 may include, for example, a mapping table or mapping function that associates various operating conditions with shaft-wheel torque distribution parameters, such as electrical energy requirements.

At block 718, the system 100 determines whether an electrical failure has occurred. In some embodiments, the system 100 may actively monitor for a failure condition while in other embodiments, an electrical failure may simply occur, at block 718. If an electrical failure has occurred, the electromagnetic coupler may become inoperable, in which case a non-electromagnetic coupling engages the shaft with the rotor wheel until electrical power is restored, at block 720. If no electrical failure occurs, the system 100 simply continues without engaging the mechanical coupling. With electrical power restored or continuing, the system 100 returns to block 710 to continue monitoring turbine engine operating conditions and adjusting the shaft-wheel torque distribution as needed, in block 710.

Referring now to FIG. 8, an embodiment of the vehicle control unit 146 is shown. The illustrative vehicle control unit 146 is embodied as electrical circuitry, which may include one or more computing devices having hardware and/or software components that are capable of performing the functions disclosed herein, including the functions of the shaft torque control logic 148. As shown, the control unit 146 may include one or more other computing devices (e.g., servers, mobile computing devices, etc.), which may be in communication with each other and/or the control unit 146 via one or more communication networks (not shown), in order to perform one or more of the disclosed functions. The illustrative control unit 146 includes at least one processor 810 (e.g. a controller, microprocessor, microcontroller, digital signal processor, etc.), memory 812, and an input/output (I/O) subsystem 814. The control unit 146 may be embodied as any type of electrical circuitry, which may include one or more controllers or processors (e.g., microcontrollers, microprocessors, digital signal processors, field-programmable gate arrays (FPGAs), programmable logic arrays (PLAs), etc.), and/or other electrical circuitry. For example, portions of the control unit 146 may be embodied as a computing device, such as a desktop computer, laptop computer, or mobile computing device (e.g., handheld computing device), a server, an enterprise computer system, a network of computers, a combination of computers and other electronic devices, or other electronic devices. Although not specifically shown, it should be understood that the I/O subsystem 814 typically includes, among other things, an I/O controller, a memory controller, and one or more I/O ports. The processor 810 and the I/O subsystem 814 are communicatively coupled to the memory 812. The memory 812 may be embodied as any type of suitable computer memory device (e.g., volatile memory such as various forms of random access memory).

The I/O subsystem 814 is communicatively coupled to a number of hardware and/or software components, including a data storage device 816, communication circuitry 820, and shaft torque control logic 148. The data storage device 816 may include one or more hard drives or other suitable persistent data storage devices (e.g., flash memory, memory cards, memory sticks, and/or others). Shaft torque modulation data 818, and/or any other data needed by the shaft torque control logic 148 to perform the functions disclosed herein, may reside at least temporarily in the data storage device 816 and/or other data storage devices of or coupled to the control unit 146 (e.g., data storage devices that are “in the cloud” or otherwise connected to the control unit 146 by a network, such as a data storage device of another computing device). Portions of the shaft torque control logic 148 may reside at least temporarily in the data storage device 816 and/or other data storage devices that are part of the control unit 146. Portions of the shaft torque modulation data 818 and/or the shaft torque control logic 148 may be copied to the memory 812 during operation of the gas turbine engine system 100, for faster processing or other reasons.

The communication circuitry 820 may communicatively couple the control unit 146 to one or more other devices, systems, or communication networks, e.g., a local area network, wide area network, personal cloud, enterprise cloud, public cloud, and/or the Internet, for example. Accordingly, the communication circuitry 820 may include one or more wired or wireless network interface software, firmware, or hardware, for example, as may be needed pursuant to the specifications and/or design of the particular turbine engine system 100.

The shaft torque control logic 148 is embodied as one or more computer-executable components and/or data structures (e.g., computer hardware, software, or a combination thereof). Particular aspects of the methods and analyses that may be performed by the shaft torque control logic 148 may vary depending on the requirements of a particular design of the turbine engine system 100. Accordingly, the examples described herein are illustrative and intended to be non-limiting. Further, the control unit 146 may include other components, sub-components, and devices not illustrated herein for clarity of the description. In general, the components of the control unit 146 are communicatively coupled as shown in FIG. 8 by electronic signal paths, which may be embodied as any type of wired or wireless signal paths capable of facilitating communication between the respective devices and components.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine. For example, a machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

This disclosure is to be considered as exemplary and not restrictive in character, and all changes and modifications that come within the spirit of the disclosure are desired to be protected.

1. A gas turbine engine system comprising:
a turbine engine comprising:
a compressor drive shaft;
a compressor having a plurality of rotor wheels and a plurality of blades extending radially from each rotor wheel, each of the rotor wheels being rotatable with the compressor drive shaft and rotatable about the compressor drive shaft; and
an electromagnetic coupler electromagnetically coupling the rotor wheels to the compressor drive shaft; and
control circuitry to selectively vary a supply of electrical energy to the electromagnetic coupler.

2. The gas turbine engine system of claim 1, wherein the electromagnetic coupler comprises a shaft-side electromagnetic coupler mounted to the compressor drive shaft.

3. The gas turbine engine system of claim 1, wherein the shaft-side electromagnetic coupler is disposed adjacent an outer diameter of the compressor drive shaft.

4. The gas turbine engine system of claim 3, wherein the shaft-side electromagnetic coupler comprises a magnetic material.

5. The gas turbine engine system of claim 1, wherein the electromagnetic coupler comprises a wheel-side electromagnetic coupler mounted to the multistage axial compressor.

6. The gas turbine engine system of claim 5, wherein the wheel-side electromagnetic coupler is disposed adjacent an inner diameter of each rotor wheel.

7. The gas turbine engine system of claim 6, wherein the wheel-side electromagnetic coupler comprises a magnetic material, and the shaft-side electromagnetic coupler comprises a magnetic material having the opposite polarity as the magnetic material of the wheel-side electromagnetic coupler.

8. The gas turbine engine system of claim 1, wherein the electromagnetic coupler comprises a wheel-side electromagnetic coupler disposed adjacent an inner diameter of each rotor wheel and a shaft-side electromagnetic coupler disposed adjacent an outer diameter of the compressor drive shaft.

9. The gas turbine engine system of claim 8, wherein the wheel-side electromagnetic coupler and the shaft-side electromagnetic coupler each comprise a solenoid array.

10. The gas turbine engine system of any of the preceding claims, wherein each of the rotor wheels is concentric with the compressor drive shaft and separated from the compressor drive shaft by a gap.

11. The gas turbine engine system of claim 1, comprising a power supply to supply electrical energy to the shaft-side electromagnetic coupler and the wheel-side electromagnetic coupler.

12. The gas turbine engine system of claim 9, wherein the power supply comprises a generator coupled to the compressor drive shaft.

13. The gas turbine engine system of claim 1, comprising a non-electromagnetic coupler to couple the compressor drive shaft to the rotor wheels in response to an electrical failure in the gas turbine engine system.

14. The gas turbine engine system of claim 11, wherein the non-electromagnetic coupler comprises a spring-loaded clutch.

15. The gas turbine engine system of claim 1, comprising shaft torque control logic embodied in one or more non-transitory machine readable storage media, wherein the shaft torque control logic is executable by the electrical circuitry to cause the gas turbine engine system to selectively vary the supply of electrical energy to the electromagnetic coupler to arbitrarily vary the distribution of shaft torque among the rotor wheels.

16. The gas turbine engine system of claim 1, comprising shaft torque control logic embodied in one or more non-transitory machine readable storage media, wherein the shaft torque control logic is executable by the electrical circuitry to cause the gas turbine engine system to selectively operate in a plurality of different states, wherein the plurality of different states includes (i) a “locked” state in which torque is transmitted from the compressor drive shaft to the rotor wheels; and
(ii) a “slipped” state in which torque transfer from the compressor drive shaft to the rotor wheels is modulated.

17. The gas turbine engine system of claim 16, wherein the shaft torque control logic is executable by the electrical circuitry to cause the gas turbine engine system to operate in (iii) a “pressed” state in which the rotation speed of the rotor wheels is higher than the rotation speed of the compressor drive shaft.

18. A compressor for a gas turbine engine, the compressor comprising:
a plurality of compressor stages, each stage comprising a rotor and a stator, each rotor comprising a rotor wheel and a plurality of blades extending radially from the rotor wheel; and
an electromagnetic coupler disposed adjacent an inner diameter of each of the rotor wheels.

19. The compressor of claim 18, comprising a compressor drive shaft and an electromagnetic coupler disposed about an outer diameter of the compressor drive shaft, wherein the rotor wheels are concentric with and mechanically disengaged from the compressor drive shaft.

20. A control unit for a gas turbine engine, the gas turbine engine comprising a compressor and a compressor drive shaft, the compressor having a plurality of bladed rotor wheels concentric with the compressor drive shaft, the control unit comprising electrical circuitry and shaft torque control logic embodied in one or more non-transitory machine readable storage media, wherein the shaft torque control logic is executable by the electrical circuitry to cause an intensity of a magnetic field between the bladed rotor wheels and the compressor drive shaft to vary to generate a continuously variable torque between the compressor drive shaft and the bladed rotor wheels.
